(19) United States
(12) Patent Application Publication
(10) Pub. No.: US 2012/0260096 A1
(43) Pub. Date: Oct. 11, 2012

(54) METHOD AND SYSTEM FOR MONITORING A SECURE DOCUMENT

(76) Inventors: Helen BALINSKY, Cardiff (GB); Steven J. Simske, Fort Collins, CO (US)

(21) Appl. No.: 13/082,746

(22) Filed: Apr. 8, 2011

(51) Int. Cl. G06F 21/24

(52) U.S. Cl. 713/176

(57) ABSTRACT

A method for enabling access to a secure document by a document service includes receiving the document, and an ordered sequence of signature verification keys that are to be selected in an orderly manner, from a document owner. Access is enabled to the document via an allocated access address. Uploading an uploaded document is enabled. A signature associated with the uploaded document is verified using a currently selected signature verification key from the ordered sequence. If verification fails, the uploaded document is rejected. If verification succeeds, the document accessible via the allocated access address is replaced with the uploaded document and a next signature verification key of the ordered sequence is selected to be the currently selected signature verification key.

### BACKGROUND

A secure composite document, such as a publicly posted composite document (PPCD), enables a plurality of participants in a workflow to access a digital document. The composite document is divided into a plurality of individually addressable and accessible units or parts. The units may be in the form of individual files or addressable file fragments. For example, a unit may include an entity such as a presentation slide, word processor text box, individual page or sheet of a spreadsheet document, a drawing, a flash video object, a Hypertext Markup Language (HTML) fragment, or an Extensible Markup Language (XML) node. Different units of a document may be in the same format, or in different formats.

A secure composite document has embedded self-enforced differential access. Each unit of the composite document is individually encrypted. This enables a document to be safely exported to outside of a secured enterprise (e.g. outside a firewall), where it may be shared or distributed using non-secure media and channels, including compact disc (CD), DVD, universal serial bus (USB) keys, and e-mail, while maintaining any required access control.

The various participants of a workflow may be granted varying levels of access to the various units. For example, levels of access may include “no access”, “read access”, or “modify access”. A single unit of the document may be associated with different sets of access keys. For example, such keys may include a verification key, an encryption key, a decryption key, and a signature key. Access keys for the unit are distributed to each workflow participant based on that participant's level of access. For example, a participant with “no access” level may be provided with only the verification key for verifying a signature attached to the document. A participant with “read access” may be provided with both the verification key and the decryption key, to enable access to the contents of the document. A participant with “modify access” may be provided with all of the aforementioned keys, to enable re-encryption and signing of the modified document.

### BRIEF DESCRIPTION OF THE DRAWINGS

Reference is made to the accompanying drawings, in which:

FIG. 1 is a schematic diagram of a system for implementation of secure document referencing and monitoring, in accordance with an embodiment of the invention;

FIG. 2 schematically illustrates updating a document in accordance with an embodiment of the invention; and

FIG. 3 is a flowchart of a method for secure document monitoring in accordance with embodiments of the present invention.

### DETAILED DESCRIPTION

In accordance with an embodiment of the invention, a secure document or composite document, or an individually addressable part or unit of a composite document (any of which being hereinafter referred to as a document), is to be accessed by a series of workflow participants in a particular order, hereinafter referred to as the access order. A document service is provided whereby the document is made available accessible to all of the workflow participants. For example, the document may be accessible via an address in a network or on a shared drive or common repository.

The document service may thus enable a composite document to be shared, distributed and referenced on-line. The document service operates without authenticating users or enforcing access control over the document. The document service may enable differential persistent remote access to parts of a secure composite document without having been provided the identities or access rights of those accessing the document. Furthermore, the document service need not access the encrypted contents of the document, or be provided with any of its access keys or codes for decrypting or modifying the document.

The document may be uploaded or provided to the document service by a document owner or master, e.g. an author or creator. The document as provided to the document service is signed by the owner. The document service is also provided with a sequence of signature verification keys for the document. Each signature verification key of a sequence corresponds to a signature key that is provided to each workflow participant who is authorized to modify the document. The first signature verification key of the sequence may correspond to the current signature (e.g. of the document owner). The order of the subsequent signature verification keys in the sequence corresponds to the access order for the workflow participants.

When a document is uploaded to the document service, a document access address is issued. The document may be accessible (albeit in encrypted form) via the document access address to a wider group than the workflow participants (e.g. all users of the appropriate network or open Internet). For example, document parts that are individually addressable within a PPCD are made to be individually addressable on-line. A part, e.g. part123, can be addressed on-line through a fragment identifier, e.g. http://some_document_service/documentID#part123, or thought an individual Uniform Resource Locator (URL), e.g. http://some_document_service/documentID/part123.

As another example, document may be made available as a file, folder, or directory on a shared data storage drive or common repository. Individual parts of a document may be available as individual files or subdirectories of a file, folder, or directory (e.g. as a component file of a Zip file). In this case, the document service at all times maintains a secure copy of the document, which is the latest verified version according to the document workflow. The secure copy is only available to the service, and may not be accessed by a workflow participant or other user.

A workflow participant, as well as anyone else with access to the document access address, may attempt to upload a revised version of the document (e.g. upload a file to a network address, or replace a file in a common repository). A valid upload must consist of two parts: the document to be updated and an accompanying document signature. A workflow participant may generate a document signature by utilizing a corresponding signature key. Whenever an upload attempt is made, however, the document service attempts to verify any accompanying signature by using a currently selected signature verification key. This verification key is selected from the sequence of signature verification keys that was provided by the document owner. If the signature is not verified as being valid, the signature verification fails. The uploaded document is then discarded and not made available via the document access address. On the other hand, if the accompanying signature is verified as valid, verification succeeds and the uploaded document is made available via the document access address. A copy of the uploaded document may also be stored as a (locally) secure copy.

A workflow participant with appropriate access to the document (e.g. having been provided with a key that enables read or read and write access) may at any time read the document, reference it, include the document in another file or document, or include it by reference. However, any attempt to modify or delete the document that is not in accordance with the workflow is rejected.

In the case of a composite document, the workflow may also determine a specific order of access to component documents. For example, it may determine that a document component A may be modified by workflow participant X only after component B was modified by workflow participant Y. The signature verification key sequence may thus include keys that are specific to a particular workflow participant and a particular document component. Typically, a signature verification key sequence only includes keys that correspond to those stages of the workflow order where a document is to be modified or edited.

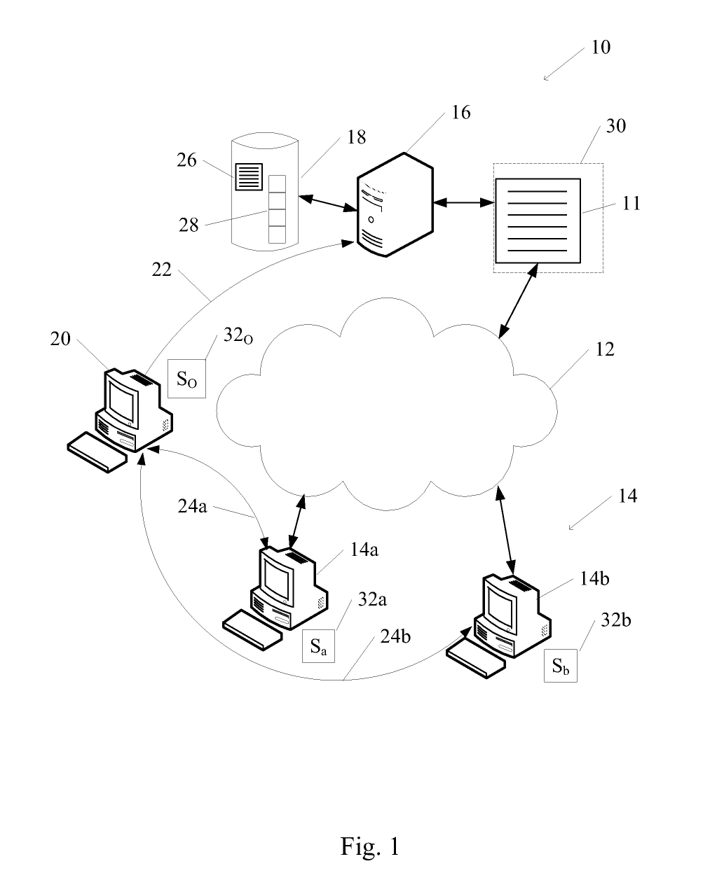

FIG. 1 is a schematic diagram of a system for implementation of secure document accessing, referencing, and monitoring, in accordance with an embodiment of the invention. Secure document system 10 enables access to and monitoring of document 11 as document 11 is modified by a plurality of authorized users, each operating a processor (e.g. computer or computer terminal) that enables reading or updating document 11. These processors are referred to as workflow participants 14, such as workflow participants 14a and 14b. Each workflow participant 14a and 14b is associated with a data storage device. The processor that is associated with each workflow participant 14a and 14b communicates with one or more input and output devices. For example, each input or output device may enable a human operated associated with each workflow participant 14 to access or modify a document. In accordance with a defined workflow, document 11 is to be modified by workflow participants 14a and 14b in a predefined order.

Document 11 is accessible via network 12. Thus, anyone with access to network 12 may access document 11. Thus, workflow participants 14, having access to network 12, may access document 11. Network 12 may be understood as representing any network that enables communication among various processors, such as the processors associated with workflow participants 14a and 14b. In particular, network 12 may represent the Internet or any other publicly accessible network (e.g. a mobile phone network). Alternatively, network 12 may represent an environment wherein a repository or drive that is shared among workflow participants 14.

In accordance with an embodiment of the invention, a processor (or a plurality of intercommunicating processors) that is associated with document service 16, and hereinafter referred to as document service 16, is configured to monitor a workflow associated with document 11. By monitoring the workflow, document service 16 may ensure availability of an authenticated copy of document 11, and only an authenticated copy, via network 12.

Document service 16 may be executed as a server application on a server, such as, for example, a web server, as an administrator-run daemon on a shared drive (e.g. in a Linux or UNIX environment), or as an administrator-run service on a shared drive (e.g. in a Windows environment).

Document service 16 may be described as a light service, with minimal running requirements. For example, document service may run without the need for a full web server (e.g. access control, or Secure Sockets Layer (SSL) support). For example, document service 16 may include only an administrator-operated daemon running on a shared drive or repository.

Document service 16 is associated with a data storage device 26. Data storage device 26 may include a plurality of fixed or removable data storage devices that are accessible by document service 16. Data storage device 26 may be used to store a secure copy 26 of document 11. As document 11 is modified in an authorized manner, additional secure copies 26 may be stored. Alternatively, only the most recent version of secure copy 26 may be stored.

Data storage device 18 may be used to store a sequence of signature verification keys in the form of signature verification key sequence 28. In addition, data storage device 18 may be used to store programming or programmed instructions, as well as any other required data, for operation of document service 16.

Document 11 may originate from a processor associated with document owner 20, hereinafter referred to as document owner 20. For example, document owner 20 may represent a processor associated with one or more authors or creators of document 11, or with an administrator who is responsible for work on document 11. As another example, document owner 20 may represent a policy set by an environment or organization in which the document exists, and which determines the work order. Any, or any combination, of the above are to be understood as included in the term “document owner”,

In accordance with an embodiment of the invention, document owner 20 determines a level of access that is granted to each participant in a workflow, such as to workflow participant 14a or 14b. Document owner 20 also determines a workflow order that sets an order according to which various workflow participants 14 may access document 11. For example, a workflow order may determine that workflow participant 14a may modify document 11 prior to workflow participant 14b.

A workflow order may determine that document 11 returns to a single workflow participant one or more times after that workflow participant, and one or more other workflow participants, have already accessed document 11 a previous time. For the purpose of this description, each such separate single access by a workflow participant to the document the document at various steps of the workflow is considered as an access by a separate workflow participant. The term “workflow participant” is thus to be understood as referring to a single access by a single workflow participant (processor).

For example, a workflow order may determine that a first workflow participant 14a modifies a document 11, after which a second workflow participant 14b modifies document 11, after which first workflow participant 14a further modifies document 11. For the purpose of this description, in such a case, the document is considered to have been accessed by three separate workflow participants 14.

Each workflow participant 14a or 14b is provided with one or more keys for enabling each workflow participant's granted level of access to document 11. For example, each workflow participant 14a or 14b may extract an appropriate access key from document 11 using that workflow participant's corresponding key map entry into the document serialization. In another embodiment, document owner 20 may provide an appropriate key to each of workflow participants 14a or 14b via a separate secure channel 24a and 24b, respectively.

Secure channels 24a and 24b may be understood to include communication in a secure manner via network 12. For example, secure channels secure channels 24a and 24b may represent an encrypted key-map file that is made accessible together with, or that is embedded in, document 11 (e.g. via document access address 30 as described below). Typically, a separate key map file is provided for each workflow participant 14a or 14b. Each key map file may include all keys that are associated with the corresponding workflow participant 14a or 14b. The key of the key map that is intended for use by a workflow participant 14a or 14b may have been encrypted using a public key associated with the corresponding workflow participant 14a or 14b.

Alternatively, secure channels 24a and 24b may represent an offline distribution, not via network 12. Offline distribution may include physical delivery to each workflow participant 14a and 14b of a data storage medium (e.g. a flash memory, optical data storage medium, or magnetic data storage medium) that contains a key appropriate to that workflow participant, or any other method of conveying a key (including delivery of a written or printed character string, or oral delivery of such a string).

In particular, if each of workflow participants 14a and 14b is to modify document 11, each may be provided with an appropriate signature key 32a or 32b, respectively. Each signature key 32a or 32b identifies the workflow participant 14a or 14b to which the signature key was provided. In addition, a workflow participant may be provided with any other relevant keys as needed to achieve a granted level of access. Such keys may include an encryption key or a decryption key.

Document owner 20 submits information to document service 16 so as to enable document service 16 to manage a workflow of document 11. Information is submitted by document owner 20 to document service 16 in a manner that includes a secure channel 22. For example, secure channel 22 may include transferring data via network 12 in a secure manner. Such a secure manner may include, for example, communication over secure channel such as SSL or Transport Layer Security (TLS). Such a secure manner may ensure that the document and sequence of signature verification keys is received undamaged by document service 16.

For example, document service 16 may be treated as a type of workflow participant whose contribution to the document workflow is to enable access to a current version of document 11 (e.g. online) Thus, document service 16 may access the required sequence of signature verification keys by application of its key-map file.

Alternatively, in accordance with an embodiment of the present invention, document owner contacts and communicates with document service 16 via the Internet. Document service 16 may provide document owner 20 with a user interface such as a data upload form. The data upload form enables document owner 20 to provide to document service 16 a signed (e.g. accompanied by a signature created using signature key 32ₒ) initial version of document 11, and signature verification key sequence 28. The first signature verification key of the sequence corresponds to signature key 32ₒ of the initial version of document 11. The remaining signature verification keys of signature verification key sequence 28 correspond to the signature keys (e.g. signature keys 32a and 32b) provided to workflow participants 14 that are granted a level of access to document 11 that permits modification of document 11. The order of the signature verification keys in signature verification key sequence 28 corresponds to the workflow order in which the various workflow participants 14 are to access and modify document 11.

When document 11 and signature verification key sequence 28 have been provided to document service 16, document service 16 issues a document access address 30. Document access address 30 enables persistent (e.g. throughout the duration of the workflow) access to document 11 via network 12. For example, document access address 30 may be in the form or syntax of a URL address. If document 11 is in the form of a part of a document, document access address 30 may be in the form of a Hypertext Markup Language (HTML) identifier that is appended to a URL, or as a separate URL. For example, a document URL may correspond to an on-line directory where document 11 (or a collection of related documents representing individually addressable parts of a document) is accessible. Alternatively, document access address 30 may represent a local path, a shared drive, or a directory or similar structure on a shared data storage drive or repository.

Document access address 30 may be accessible by anyone with access to network 12 (which could be the open Internet). Document service 16 is configured to ensure that the copy of document 11 that is accessible via document access address 30 is the current authorized version of document 11. Typically, the copy of document 11 that is accessible via document access address 30 is encrypted or otherwise protected from unauthorized access to the contents of document 11. (If document 11 represents a part of a composite document, each individually addressable part of the composite document may be encrypted separately.)

Anyone accessing document service 16, whether a workload participant or anyone else, may download or access document 11. Similarly anyone accessing document service 16 may attempt to upload a modified version of document 11 to document service 16.

For example, a user interface, such as a data upload form, may be provided for uploading a modified version of document 11 to document service 16 (e.g. when network 12 represents the Internet). Document service 16 is configured to accept only a legitimate modification of document 11 (e.g. a copy of document 11 that was modified by the correct workflow participant in the correct workflow order) in place of a previously saved version of document 11.

Document service 16 may maintain a secure copy 26 of document 11 on data storage device 18. For example, a secure copy 26 may be maintained when network 12 represents a shared drive. In this case, a user may attempt to replace document 11 with a modified document not in accordance with the workflow, or may attempt to delete document 11. In this case, document service 16 may restore document 11 with a copy of secure copy 26.

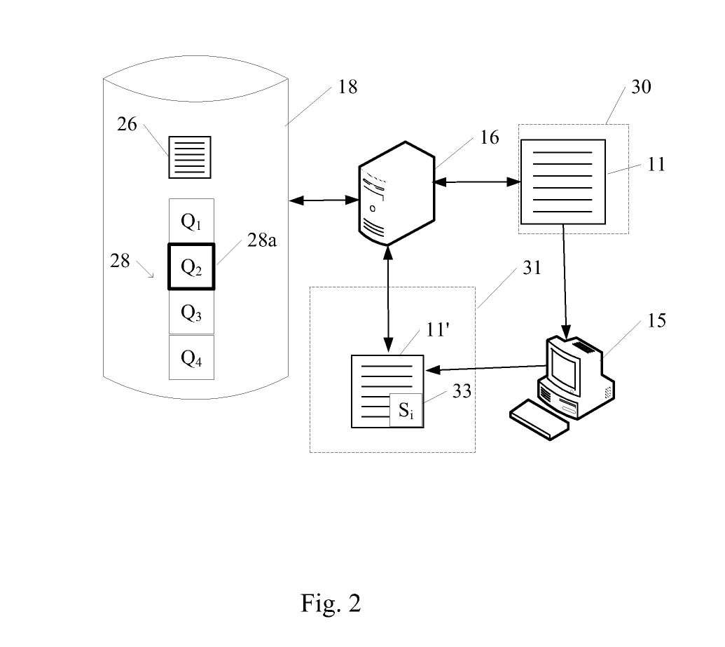

FIG. 2 schematically illustrates updating a document in accordance with an embodiment of the invention. A user 15, which may or may not be a workflow participant, attempts to upload a modification of document 11, e.g. uploaded document 11′, to document upload address 31. User 15 attaches signature 33 (here designated Sᵢ) to uploaded document 11′. Signature 33 may be uploaded together with, or separately from, uploaded document 11′. (In the case that document access address 30 represents a directory or file on a shared drive, document upload address 31 may be considered to be identical with document access address 30.)

Document service 16 may monitor document access address 30 (e.g. when document access address 30 represents a directory or file on a shared drive), as well as document upload address 31. Document service 16 may maintain in data storage device 18 secure copy 26 of document 11, as well as signature verification key sequence 28. Document service 16 is configured to monitor progress of the workflow. In monitoring progress of the workflow, document service 16 maintains a pointer (e.g. in the form of an index or address, an argument for a look-up table location, or a URL) to a signature verification key of signature verification key sequence 28 record that is to be applied next, e.g. currently selected signature verification key 28a (here designated as signature verification key Q₂).

When uploaded document 11′ is uploaded to document upload address 31, document service 16 may detect the uploading of uploaded document 11′.

Alternatively, (e.g. when document upload address 31 and document access address 30 represent a file or directory on a shared drive), when uploaded document 11′ is uploaded to document upload address 31, document service 16 may detect the replacement of document 11 with uploaded document 11′ (or deletion of document 11).

Document service 16 may apply currently selected signature verification key 28a to verify signature 33 of uploaded document 11′. Application of currently selected signature verification key 28a to signature 33 may indicate either successful verification, or failed verification.

If application of currently selected signature verification key 28a to signature 33 of uploaded document 11′ indicates successful verification, the modifications to the document are assumed to be acceptable. For example, successful verification may indicate that signature 33 corresponds to a signature of a workflow participant who is next scheduled to provide an uploaded document 11′ in accordance with the workflow order.

When successful verification is indicated, document service 16 makes uploaded document 11′ available via document access address 30 to all who have access to network 12. A copy of uploaded document 11′ may be saved on data storage device 18 as secure copy 26. Previous versions of secure copy 26 may also be saved (e.g. together with a time stamp). Saving previous versions of secure copy 26 may enable reconstructing earlier versions in the event that a problem with a current version is detected (e.g. by a workflow participant). Upon successful verification, document service 16 also increments the pointer to currently selected signature verification key 28a to the next indicated signature verification key of signature verification key sequence 28 (e.g. to the signature verification key Q₃ in the example shown in FIG. 2).

When failed verification is indicated by application of currently selected signature verification key 28a to signature 33 of uploaded document 11′, document service 16 rejects uploaded document 11′. For example, failed verification may indicate that uploaded document 11′ was uploaded to document upload address 31 by one who is not a participant in the workflow, or by a workflow participant out of order.

Upon failed verification, document service 16 deletes uploaded document 11′ from document upload address 31. Document 11 continues to be made available via document access address 30.

When document access address 30 and document upload address 31 represent a single directory or file on a shared drive, uploading uploaded document 11′ may entail replacing document 11 as accessible via document access address 30. In this case, upon failed verification, uploaded document 11′ (or the document currently accessible via document address 30) may be replaced with a copy of secure copy 26.

Document service 16 may be programmed to send a message or notification to user 15 who uploads an uploaded document 11′ that fails verification. For example, the document service may be programmed to check ahead in signature verification key sequence 28 to check if signature 33 corresponds to a later stage of the workflow (e.g. uploaded document 11′ was submitted prematurely). If so, a notification may inform user 15 to resubmit uploaded document 11′ at a later time.

In this manner, document service 16 may provide access to an authorized version of a document 11 via a document access address 30, without being provided specific information regarding either the contents of document 11 or regarding any of workflow participants 14. Thus, document service 16 may be maintained by a third-party service provider without requiring that the service providing be given access to confidential information.

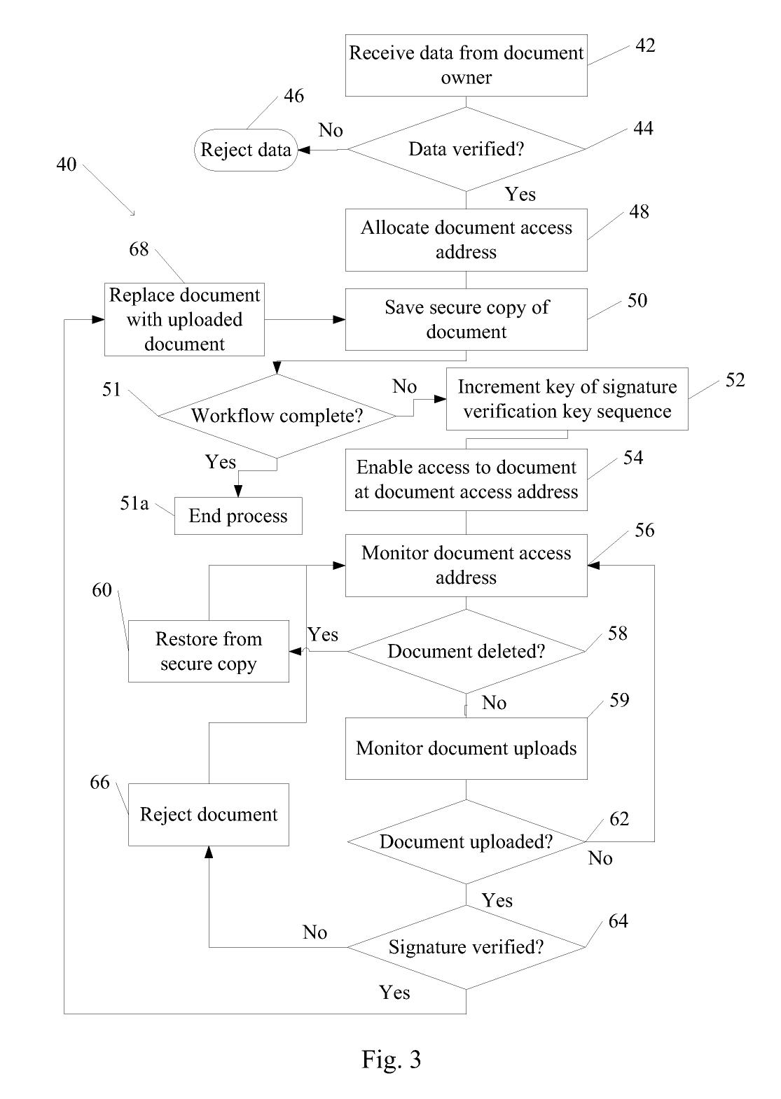

FIG. 3 is a flowchart of a method for secure document monitoring in accordance with embodiments of the present invention. Secure document monitoring method 40 may be executed by a document service, such as document service 16 (FIG. 1).

It should be understood that the division of secure document monitoring method 40 into discrete steps is arbitrary, having been selected for convenience of the description only. Alternative division of secure document monitoring method 40 into steps is possible with equivalent results. All such equivalent division of secure document monitoring method 40 into alternative steps are to be considered as falling within the scope of embodiments of the invention. Unless where otherwise stated, the order of the steps of secure document monitoring method 40 is arbitrary, having been selected for convenience of the description only. Alternative ordering, or concurrent execution, of steps of secure document monitoring method 40 may be possible with equivalent results. All such equivalent reordering of steps of secure document monitoring method 40 are to be considered as falling within the scope of embodiments of the invention.

Data in the form of an initial version of a document, which may be signed, together with an accompanying signature verification key sequence, is received from a document owner (step 42). For example, the document owner may be an author or administrator of the document. A currently selected first signature verification key of the signature verification key sequence may be assumed to correspond to a signature key that is assigned to the document owner. The data may be received from the document owner in a secure manner (e.g. hybrid cryptography), or may be securely received using a key derived from an encrypted key-map that is assigned to the document service.

The first signature verification key of the signature verification key sequence may be applied to the signature that is attached to the initial version of the document, in order to verify validity of the received data (step 44). If the result of the application indicates failed verification, the data is rejected (step 46). For example, failed verification may indicate that the document had no signature attached, or that there is inconsistency between attached signature and the first signature verification key of the signature verification key sequence.

If application of the first signature verification key to the signature of the initial version of the document indicates successful verification, a document access address is allocated (step 48). The document access address may be allocated, for example, on a network (which, as described above, is understood to include allocating a directory or similar structure on a shared-drive or shared-repository environment). Allocation of the document access address may be communicated to the document owner, or may be published via the network. The document access address remains valid throughout execution of secure document monitoring method 40.

A secure copy of the initial version of the document may be saved on an associated data storage device (step 50). Alternatively (e.g. in the case of a web service accessible via a user interface) no secure copy need be saved (except for backup or rollback purposes). Access to the secure copy is limited to the document service only.

The document service may check whether the workflow is complete (step 51). For example, the document service may check the signature verification key sequence to verify that the sequence includes at least one signature verification key after the currently selected signature verification key. If no more signature verification keys are available, the process defined by secure document monitoring method 40 ends (step 51a). At this point, the document service may perform a predetermined action. Such an action may include, for example, notifying the document owner or another party, or automatically sending the current (final) version of the document (e.g. by email) to an appropriate party.

If the workflow is not complete, a pointer to a currently selected signature verification key of the signature verification key sequence is advanced (or incremented from its current position, e.g. the first signature verification key) to the next (e.g. the second) signature verification key in the signature verification key sequence (step 52). Access to the initial version of the document is enabled via the document access address (step 54).

The document service may monitor the accessible copy of the document that is accessible via the document access address (step 56). Alternatively, e.g. when the document access address is accessible via a user interface of a web site, no such monitoring may be necessary (as the document may not be directly modified by a user). For example, monitoring the accessible copy of the document may detect if the accessible copy of the document (which, as described above, is understood as including an accessible copy of a part of a larger document) is deleted (step 58). This may occur, for example, when the accessible copy is accessible via a shared drive or common repository. If the accessible copy is deleted, the accessible copy is restored by replacing the accessible copy with a copy of the saved secure copy (step 60). Monitoring of the accessible copy document at the document access address continues (returning to step 56).

Monitoring a document upload address (step 59) may detect that a document was uploaded (step 62). If an uploaded document is detected, the currently selected signature verification key of the signature verification key sequence is applied to a signature attached to the uploaded document to verify the attached signature (step 64).

If application of the currently selected signature verification key indicates failed verification (e.g. no signature is attached to the uploaded document or the attached signature is not the expected one), the uploaded document is rejected (step 66). Monitoring of the accessible copy of the document at the document access address continues (returning to step 56).

If application of the currently selected signature verification key indicates successful verification of the uploaded document (e.g. the attached signature is associated with the expected workflow participant), the uploaded document replaces the accessible copy of the document (step 68). The uploaded document is saved as the secure copy (returning to step 50—either in addition to or in place of the previously saved secure copy). The pointer to, or selection of, the currently selected signature verification key of the signature verification key sequence is incremented to the next signature verification key of the sequence (returning to step 52). Access to the uploaded document (and only to the uploaded document) is enabled via the document access address (returning to step 54). Monitoring of the accessible copy of the document at the document access address continues (returning to step 56).

In this manner, a current version of the document is always accessible via the document access address to anyone with access to the appropriate network. The contents of the document may be available to anyone who is able to properly interpret the document file (e.g. able to decrypt the document). The only modifications to the document that affect the current accessible copy of the document are those modifications whose validity is verifiable by application of the current signature verification key (e.g. only by workflow participants and in accordance with the workflow order).

Thus, an authorized user (e.g. a user that was provided with a valid decryption key), by accessing the document access address, may be assured of accessing a valid copy of the document. Access to the document may enable the authorized user to include or include through reference (“transclude”) the secure document in another document. Transcluding may provide a user who does not have access to the secure document (e.g. was not provided with a decryption key) with the ability to read the secure document via the other document. Transcluding may enable one or more authorized users to have (reading) access to a current version of the secure document as the secure document is modified throughout the course of the workflow.

Provision of a document access address may provide a convenient and secure access point to the document to all workflow participants. The identities of users who access the document need not be made available to the document service.

A document service in accordance with an embodiment of the invention may enable monitoring or auditing of progress of the document through the workflow by the document owner or another authorized party. For example, when the current signature verification key has been incremented (or when progress of the document through the workflow is otherwise indicated), a notification may be sent to the document owner. For example, the notification may include an index of the current signature verification key. Such an index may be of significance only to the document owner or other party responsible for administering the workflow.

For a document with multiple parts, each part may be treated as a separate document, with its own workflow, workflow participants, and signature verification key sequence. Such a division of the document may enable a reduction in network traffic.

In accordance with an embodiment of the invention, an authorized party may monitor progress of the workflow. For example, the authorized party may include the document owner or an authorized workflow participant. The authorized party may be provided with sufficient keys to enable the required level of monitoring.

For example, an authorized party (e.g. one of the workflow participants) may be authorized to monitor content of the document as it progresses through the workflow (e.g. one or more parts of a composite document). In this case, the authorized party may be provided with decryption keys related to the document (e.g. a sequence of decryption keys for a single document if the encryption changes during the course of the workflow), as well as a corresponding sequence of signature verification keys. For example, the keys may be obtained by the authorized party via an appropriate key map.

As another example, an authorized party may be authorized to monitor the progress of the document through the workflow without monitoring the document's content. In this case, the party may be provided only with the sequence of signature verification keys.

The authorized party may periodically access or download the document via the document access address. For example, the periodic accessing may be performed automatically by an appropriately configured processor (running a script or software application). Verification of the current document signature by a signature verification key of the sequence may indicate a stage of the workflow (e.g. by determining the position in the sequence of a signature verification that successfully verifies the signature of the last workflow participant to modify the document—without necessarily having access to the identity of the last workflow participant). In addition, successful verification of the document of the signature may indicate that the accessed document has not been damaged. The authorized party may also monitor such publicly available aspects of the document as a file size. In addition, a party that is authorized to monitor the content of the document may decrypt and read the accessed document using the appropriate decryption key. A protection mechanism may be applied to protect any information the document file that is not to be made publicly available (e.g. file size or file name obfuscation).

A document service, in accordance with an embodiment of the invention, may be implemented in the form of software, hardware or a combination thereof.

Aspects of the invention may be embodied in the form of a system, a method or a computer program product. Similarly, aspects of the invention may be embodied as hardware, software or a combination of both. Aspects of the invention may be embodied as a computer program product saved on one or more non-transitory computer readable medium (or mediums) in the form of computer readable program code embodied thereon.

For example, the computer readable medium may be a non-transitory computer readable storage medium. A non-transitory computer readable storage medium may be, for example, an electronic, optical, magnetic, electromagnetic, infrared, or semiconductor system, apparatus, or device, or any combination thereof.

Computer program code may be written in any suitable programming language. The program code may execute on a single computer, or on a plurality of computers.

Aspects of the invention are described hereinabove with reference to flowcharts and/or block diagrams depicting methods, systems and computer program products according to embodiments of the invention.

What is claimed is:

1. A method for enabling access to a secure document by a document service, the method comprising:
receiving from a document owner the document and an ordered sequence of signature verification keys that are to be selected in an orderly manner;
enabling access to the document via an allocated access address;
enabling uploading of an uploaded document and verifying a signature associated with the uploaded document using a currently selected signature verification key from the ordered sequence such that:
if verification fails, rejecting the uploaded document; and
if verification succeeds, replacing the document accessible via the allocated access address with the uploaded document and selecting a next signature verification key of the ordered sequence to be the currently selected signature verification key.

2. The method of claim 1, wherein the document is a composite document, and wherein each signature verification key of the ordered sequence is specific to a part of the composite document.

3. The method of claim 1, further comprising storing a secure copy of the document as received from the document owner and when the verification succeeds, storing a secure copy of the uploaded document.

4. The method of claim 3, further comprising replacing the document accessible via the allocated access address with a copy of the secure copy when the verification fails.

5. The method of claim 1, wherein the document service is implemented as a server application on a server, as an administrator-run daemon on a shared drive, or as an administrator-run service on a shared drive.

6. The method of claim 1, wherein each signature verification key of the ordered sequence corresponds to a workflow participant, the order of the signature verification keys in the ordered sequence corresponding to a workflow order.

7. The method of claim 1, wherein the document is encrypted.

8. A non-transitory computer readable medium containing instructions that when executed cause a processor to execute the steps of:
receiving from a document owner the document and an ordered sequence of signature verification keys that are to be selected in an orderly manner;
enabling access to the document via an allocated access address;
enabling uploading of an uploaded document and verifying a signature associated with the uploaded document using a currently selected signature verification key from the ordered sequence such that:
if verification fails, rejecting the uploaded document; and
if verification succeeds, replacing the document accessible via the allocated access address with the uploaded document and selecting a next signature verification key of the ordered sequence to be the currently selected signature verification key.

9. The non-transitory computer readable medium of claim 8, wherein the document is a composite document, and wherein each signature verification key of the ordered sequence is specific to a part of the composite document.

10. The non-transitory computer readable medium of claim 8, further comprising storing a secure copy of the document as received from the document owner and when the verification succeeds, storing a secure copy of the uploaded document.

11. The non-transitory computer readable medium of claim 10, further comprising replacing the document accessible via the allocated access address with a copy of the secure copy when the verification fails.

12. The non-transitory computer readable medium of claim 8, wherein each signature verification key of the ordered sequence corresponds to a workflow participant, the order of the signature verification keys in the ordered sequence corresponding to a workflow order.

13. The non-transitory computer readable medium of claim 8, wherein the document is encrypted.

14. The non-transitory computer readable medium of claim 8, containing instructions for providing a user interface for enabling uploading of data to the document service and for accessing the document.

15. A document service data processing system comprising:
a processing unit in communication with a computer readable medium, wherein the computer readable medium contains a set of instructions wherein the processing unit is designed to carry out the set of instructions to:
receive from a document owner the document and an ordered sequence of signature verification keys that are to be selected in an orderly manner;
enable access to the document via an allocated access address;
enable uploading of an uploaded document;
verify a signature associated with the uploaded document using a currently selected signature verification key from the ordered sequence such that:
if verification fails, reject the uploaded document;
if verification succeeds, replace the document accessible via the allocated access address with the uploaded document and select a next signature verification key of the ordered sequence to be the currently selected signature verification key.

16. The system of claim 15, wherein the allocated access address comprises a file on a shared drive or an address on a network.

17. The system of claim 15, comprising a secure channel for communicating with at least a document owner.

18. The system of claim 17, wherein the secure channel comprises hybrid key encryption or a key map associated with the document.

19. The system of claim 15, wherein an authorized party is provided with the ordered sequence of signature verification keys for enabling the authorized party to monitor a progress of the document through a workflow.
